(19) United States
(12) Patent Application Publication
(10) Pub. No.: US 2011/0222275 A1
(43) Pub. Date: Sep. 15, 2011

(54) Wire guard fluorescent fixture attachment using snap fasteners

(76) Inventors: Charles E. Kassay, Smithtown, NY (US); Suzanne M. Pane, New Bern, NC (US); Marc A. Kassay, Wake Forest, NC (US); John Peter Kassay, Wake Forest, NC (US)

(21) Appl. No.: 12/661,408

(22) Filed: Mar. 15, 2010

(51) Int. Cl. F21V 21/00

(52) U.S. Cl. 362/217.17

(57) ABSTRACT

A wire guard fluorescent fixture attachment uses snap fasteners to attach the wire guard to a fluorescent fixture. Two or more such snap fasteners are spaced apart on each side of the fixture adjacent to the bottom housing edge. Each snap fastener has three functions in this application. It fastens the wire guard to the fixture; it also hinges the wire guard to the fixture so that it can swing open in either of two directions. It is also a latch to lock the wire guard in place after a service requiring swinging the wire guard open.

### FIELD OF THE INVENTION

The present invention relates to a triple combination screen guard snap fastener for fastening a wire guard to a lighting fixture, for a hinge permitting the wire guard to swing open in either of two directions and also for a latch to lock the wire guard in place after a service requiring swinging the wire guard open.

### BACKGROUND OF THE INVENTION

Fluorescent fixtures using tubular lamps sometimes have a wire guard in the form of an open grid covering the open area underneath the lamps to protect the lamps from inadvertent impact from below. These wire guards are rather unwieldy; they are typically attached to the fixture with short strips of nylon strap or metal strip looped around an edge wire and attached via threaded studs attached to the fixture housing through holes near the distal ends of the strips. These loops are held with nuts on the studs thereby forming loose strap hinges. Alternatively, the wire guards are attached to actual hinges on one side and with latches on the opposite side so that they can be swung down to relamp or perform other service. The hinges and latches are typically attached near the bottom edge of the fixture housing using screw fasteners or rivets through an array of carefully drilled or punched holes. The initial installation is labor intensive. The wire guard typically can be swung open in only one direction since the hinges are on one side and the latches on the opposite side.

### OBJECTS OF THE INVENTION

It is therefore an object of the present invention to provide a combination screen guard snap fastener which functions in three modes, one, for fastening a wire guard to a lighting, two, for a hinge permitting the wire guard to swing open in either of two directions and three, for a latch to lock the wire guard in place after a service requiring swinging the wire guard open.

It is also an object of the present invention to provide a streamlined manufacturing operation since only one type of inexpensive snap fastener and blind rivet is required to replace a hinge and a latch.

It is yet another object of the present invention to provide a wire guard which can be replaced by opening all snap fasteners to detach the damaged guard to install a new guard without the use of any tools.

Other objects which become apparent from the following description of the present invention.

### SUMMARY OF THE INVENTION

The method of this invention using snap fasteners to attach the wire guard to the fluorescent fixture is much less labor intensive. The snap fasteners used (such as those available from Ludwig Manufacturing Co. of Racine, Wis.) are low cost; they are attached through a single hole in the housing using a single blind rivet. Two or more such snap fasteners are spaced apart on each side of the fixture adjacent to the bottom housing edge. Each snap fastener has three functions in this application. It is a means of fastening the wire guard to the fixture; it is also a hinge permitting the wire guard to swing open in either of two directions; it is also a latch to lock the wire guard in place after a service requiring swinging the wire guard open. The manufacturing operation is streamlined since only one type of inexpensive snap fastener and blind rivet is required to be inventoried replacing a hinge and a latch. If damaged, a wire guard can be replaced by opening all snap fasteners to detach the damaged guard; then a new guard is installed all without the use of any tools. The snap fasteners permit precise vibration resistant mounting of the wire guards.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a side elevation of a fluorescent fixture with a wire guard attached using snap fasteners;

FIG. 1A is a perspective view detail of the wire guard attachment using nylon or metal looped straps (prior art).

FIG. 2 is a perspective view of a snap fastener used in this invention;

FIG. 3 is an end view of the fluorescent fixture of FIG. 1;

FIG. 4 is an enlarged side detail of a latched fastener from FIG. 3;

FIG. 5 is an end view of the fixture of FIG. 1 with the wire guard swung down;

FIG. 6 is a enlarged side detail of the snap fastener acting as a hinge in FIG. 5;

FIG. 7 is an enlarged side detail showing the open snap fastener on the open side of FIG. 5;

FIG. 8 is a perspective detail of a snap fastener engaging the wire guard in a latched position;

FIG. 9 is a perspective detail of an open snap fastener disengaged from the wire guard;

FIG. 10 is an end view of a rectangular fixture with a wire guard;

FIG. 11 is an enlarged side detail showing the mounting of the snap latch on the fixture of FIG. 10;

FIG. 12 is an end view of a fixture with a reverse angled housing; and,

FIG. 13 is an enlarged side detail showing the mounting of the snap latch on the fixture of FIG. 12.

### DETAILED DESCRIPTION OF THE INVENTION

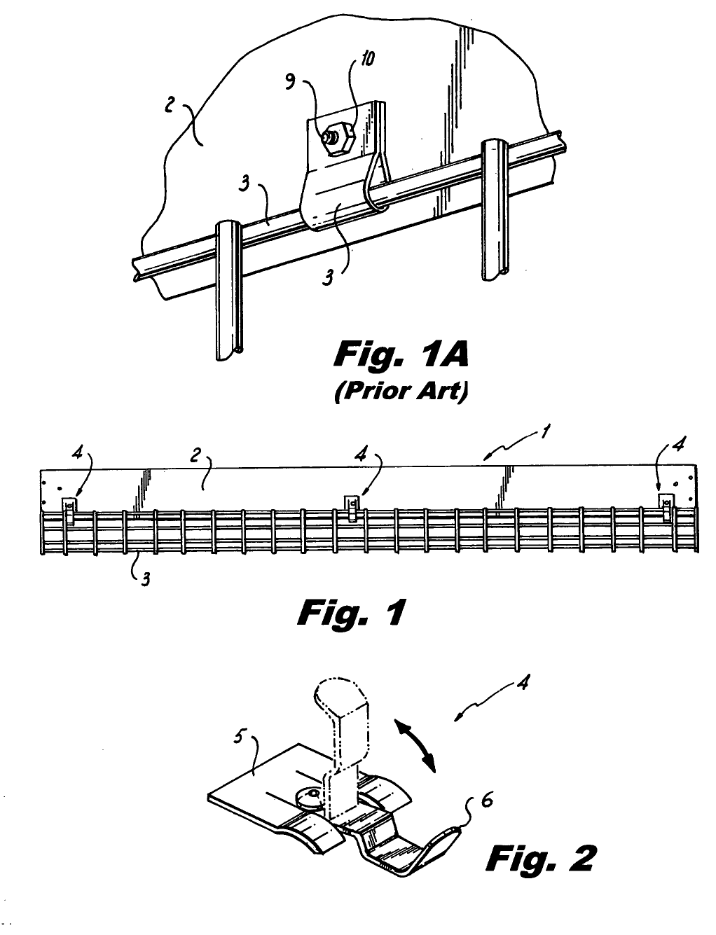

FIG. 1 shows a side view of fluorescent fixture 1 with housing 2 and wire guard 3 attached with the use of three snap fasteners 4 on each side.

FIG. 1A is a detail of a prior art method of attaching wire guards to fixtures. The end wire of wire guard 3 is captured by a loop 11 of nylon strap or metal strip with a mounting hole near each end thus forming a makeshift strap hinge. The mounting holes are guided over a threaded stud attached near the bottom side edge of fixture housing 2 and secured via nut 10. While the straps or strips 11 are inexpensive, this is a labor intensive procedure. For maintenance such as relamping, the strips on one side must be disassembled to permit the wire guard to swing down. Nuts are easily lost or dropped during this procedure. Note that this is an imprecise method of attachment because the loops are loosely formed around wire of guard 3. This method is also prone to vibration amplification.

In contrast to the prior art method of FIG. 1A, FIG. 2 shows the two-part snap fastener 4. It includes of spring plate 5 and movable arm 6 which can be moved from the latched position shown in solid lines to the open position shown in phantom view.

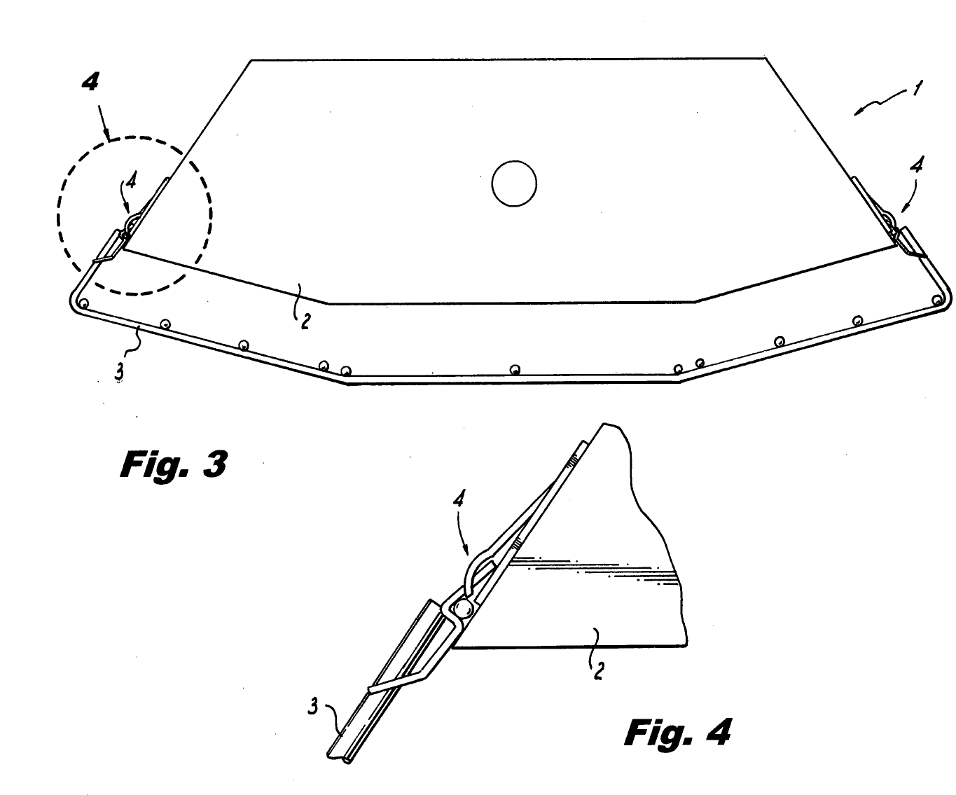

FIG. 3 shows the wire guard 3 latched on both sides of fixture 1. A detail of one of the snap fasteners 4 in the latched position is shown in FIG. 4.

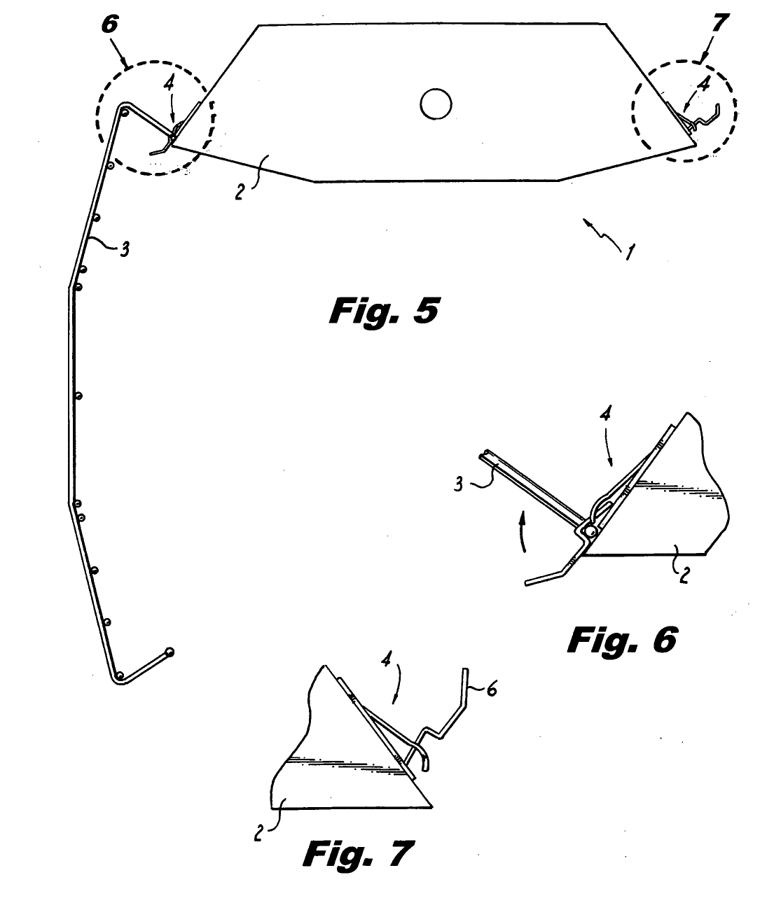

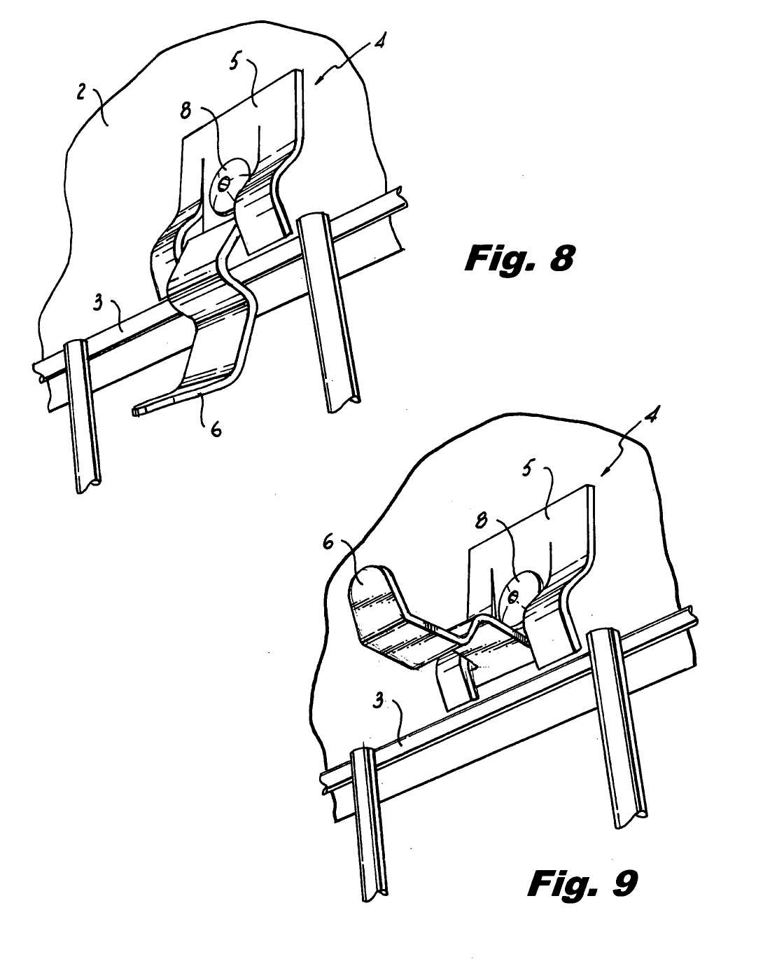

FIG. 5 shows fixture 1 with wire guard 3 swung down from the right edge and hanging from snap fastener “hinges” on the left side. The latched configuration of the “hinged” side is shown in the detail of FIG. 6, while the open snap fastener 4 of the right side is shown in FIG. 7.

FIG. 8 is an enlarged view of a snap fastener 4 with spring plate 5 attached via blind rivet 8 near the open edge of housing 2. The end wire of wire guard 3 is shown latched and captured by moving arm 6 in this view.

FIG. 9 is a similar view to FIG. 8, but now moving arm 6 has been lifted thereby disengaging it from the end wire of wire guard 3 which now can be moved away from housing 2.

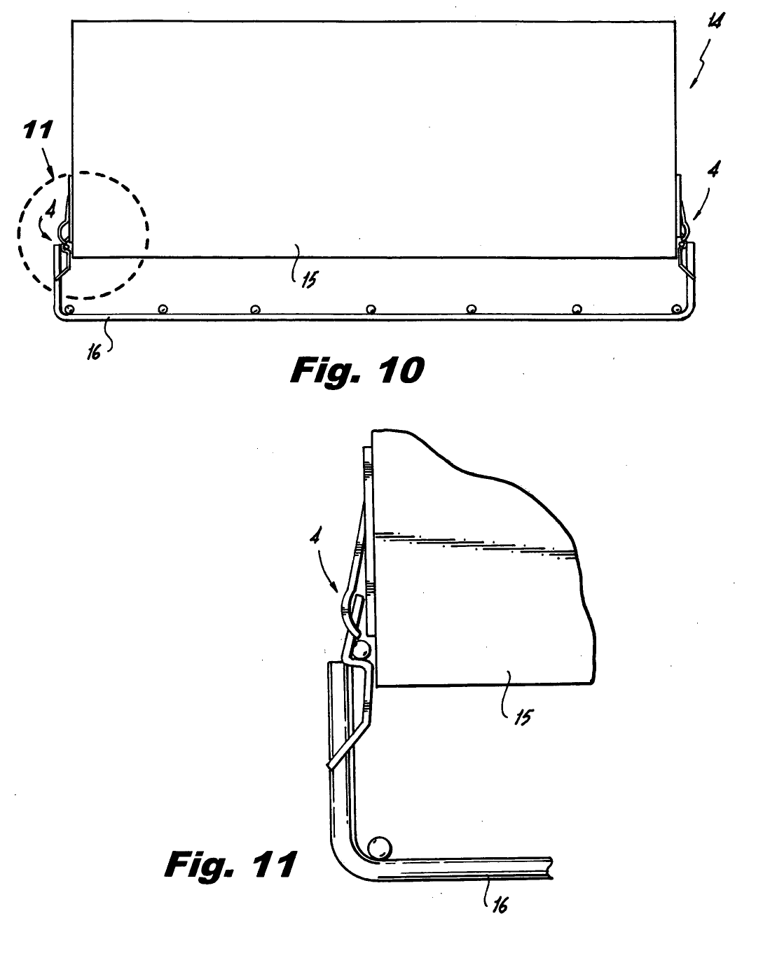

Other types of housing shapes can be similarly accommodated using this method as long as the wire guard is bent such that the end is parallel to the side of the fluorescent housing. Two other examples are shown in FIGS. 10-13.

FIG. 10 is an end view of a fixture 14 with a rectangular end view of housing 15. Wire guard 16 is attached by snap fasteners 4 on each side.

A detail of one of the latched sides is shown in FIG. 11.

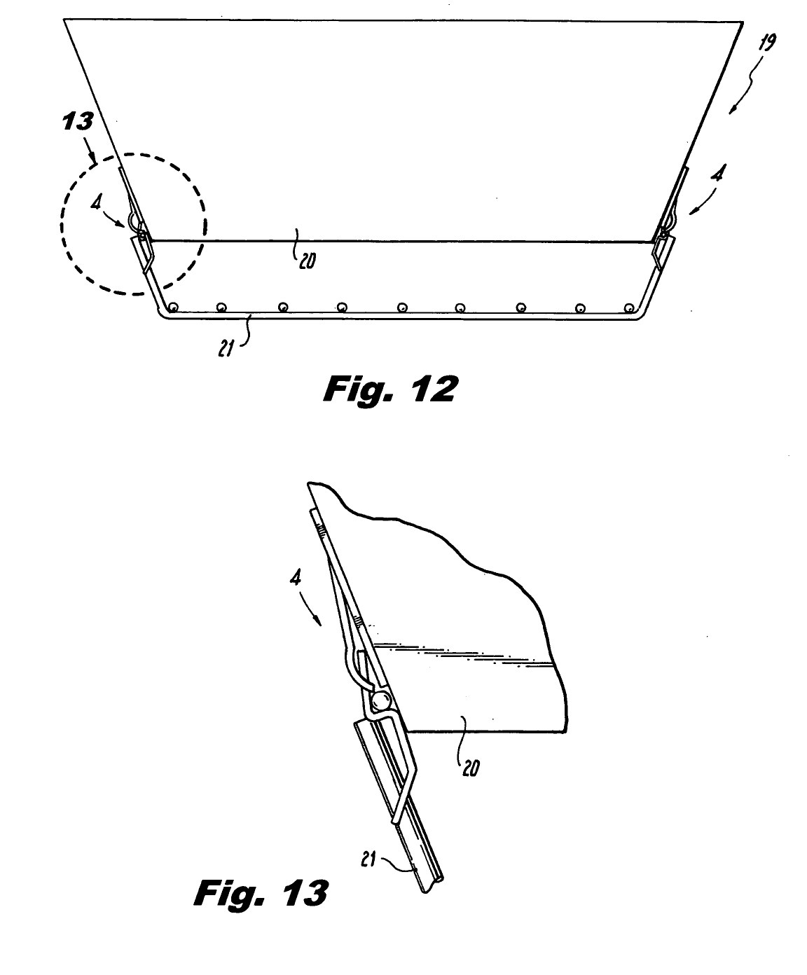

FIG. 12 is an end view of a fixture 19 with a reverse angle of housing 20. Note that the ends of wire guard 21 are bent at the same angle as housing 20.

FIG. 13 is a detail of a latched snap fastener 4.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

We claim:

1. The combination of a fluorescent fixture and a screen guard snap fastener comprising:
said fluorescent fixture having side walls and end walls with an opening exposing a fluorescent lamp;
a wire guard covering said opening;
snap fasteners attached on both side walls for supporting side edges of said screen guard;
each snap fastener having a stationary member attached to said side wall and a movable member; and
said movable member rotatable on said stationary member between a deployed position engaging an edge of said wire guard and an open position in which said movable member is disengaged from said wire guard; and
whereby said snap fasteners have three functional modes wherein in a first mode all of said snap fasteners have their movable members in a deployed position securing said wire guard to said fluorescent fixture completely covering said opening, in a second mode the movable members of only said snap fasteners on one side wall are in open position so that said wire guard is hinged open with the snap fasteners on the opposite wall acting as hinges so that said wire guard may be made to swing open from either side wall, and in a third mode wherein the movable members of all snap fasteners are open whereupon said wire guard is removable and/or replaceable.

2. The combination of claim 1 in which said snap fasteners are attached through a single hole in a side wall using a single fastener.

3. The combination of claim 2 in which said fastener is a blind rivet.

4. The combination of claim 1 wherein said wire guard is in the form of an open grid covering an open area beneath said fluorescent lamp.

5. The combination of claim 4 wherein multiple fluorescent lamps are mounted in said fixture.

6. The method of securing a screen guard to cover a bottom opening in a fluorescent fixture containing one or more fluorescent lamps comprising the steps of:
placing a wire guard over said bottom opening in said fluorescent fixture, said fixture having side walls and end walls with said bottom opening exposing a fluorescent lamp within said fixture;
attaching snap fasteners to both side walls of said fixture, each snap fastener having a stationary member attached to said side wall and a movable member, said movable member rotatable on said stationary member between a deployed position for engaging an edge of said wire guard and an open position in which said movable member is disengaged from said wire guard;
attaching opposite edges of said wire guard to said fluorescent fixture by moving each movable member of said snap fasteners on both side walls into a deployed position engaging an edge portion of said wire guard;
rotating said movable members into open positions on snap fasteners on only one side wall to rotate said wire guard to uncover said bottom opening for providing maintenance/lamp replacement without completely removing said wire guard, permitting snap fasteners on either side wall functioning as hinges as required for a specific location of said fixture; and
rotating said movable members on snap fasteners on the other side wall so that said wire guard is completely removed allowing replacement/repair of said wire guard.

7. The method of claim 6 in which each snap fastener is secured to a side wall using a single fastener and a single hole in the side wall thereby providing a streamlined manufacturing operation to mount screen guards on fluorescent lamp fixtures.
